(19) United States
(12) Patent Application Publication
(10) Pub. No.: US 2007/0251120 A1
(43) Pub. Date: Nov. 1, 2007

(54) Method of drying and pulverizing organic materials

(76) Inventor: Larry V. Connell, Yakima, WA (US)

Correspondence Address: STRATTON BALLEW, 213 S 12TH AVE, YAKIMA, WA, 98902, US

(21) Appl. No.: 11/788,786

(22) Filed: Apr. 20, 2007

Related U.S. Application Data
(60) Provisional application No. 60/794,065, filed on Apr. 20, 2006.

(51) Int. Cl. F26B 17/00

(52) U.S. Cl. 34/576; 34/586

(57) ABSTRACT

An economical, environmental friendly system for drying and micronizing an organic source material, without composting the organic nutrient and particle sources. The system can utilize a biogas, such as hydrogen, or a hydrocarbon such as methane, propane, natural gas, ethanol or diesel, as its source of fuel, in a processing engine, to drive off and separate the bound and free water, naturally present in the fertilizer source material, or raw feed stock. The final product is a disinfected nutrient or combustible fuel source that can be used as is, or alternatively upgraded into a fuel source for incineration, to produce heat, electrical and mechanical power. The organic source material is metered into the system at a distal end of the processing engine, proximate to an engine exhaust port and prior to a work chamber, which may be in the form of a spiral coil, an opposed engine configuration or a fan tower.

This application is a Non-Provisional Conversion Application claiming priority to Provisional Patent Application, Ser. No. 60/794,065, filed Apr. 20, 2006.

### FIELD OF INVENTION

The present invention relates to a process method for drying and pulverizing waste material, and more specifically the processing of organic material by a high velocity gas to reduce particle size and remove water.

### BACKGROUND

Removing different forms of water from organic matter proves to be the most difficult and expensive part of processing waste organic matter into useful products. As energy costs and labor costs increase, the efficient processing of these organic raw materials becomes more important. Additionally, present large scale agricultural practices fail to achieve long term and sustainable soil health. Soil, which provides the nutrients required to grow the healthy crops on which we depend, is quickly depleted by most modern farming systems. In attempts to industrialize and scale-up farming practices, which include the planting of a rapid succession of nutrient sapping crops that cannot replenish the soil, nature's replenishing processes are bypassed. To supplement or supplant nature, farmers must turn to industrial sources to provide sufficient quantities of fertilizers, to keep the soil infused with the required nutrients and vital organic materials. As fuel cost rise and clean burning sources of renewable resources become more difficult to obtain, a recycled material with potential use as a combustion heat source is needed. Furthermore, there is a need to economically produce these essential nutrients or organic raw materials in a form readily available for use in a feed, fertilizer, or fuel, resulting in a more commercially viable animal and plant food, and energy source.

### SUMMARY

An economical, environmental friendly system for drying and micronizing an organic source material, without composting the organic nutrient and particle sources is provided. The system can utilize a biogas, such as hydrogen, or a hydrocarbon such as methane, propane, natural gas, ethanol or diesel, as its source of fuel, in a processing engine, to drive off and separate the bound and free water, naturally present in the fertilizer source material, or raw feed stock. The final product is a disinfected nutrient or combustible fuel source that can be used as is, or alternatively upgraded into a fuel source for incineration, to produce heat, electrical and mechanical power. The organic source material is metered into the system at a distal end of the processing engine, proximate to an engine exhaust port and prior to a work chamber, which may be in the form of a spiral coil, an opposed engine configuration or a fan tower.

The process of the drying system includes generating a high velocity airstream, the high velocity airstream having sufficient temperature to vaporize substantially all water present in the organic material. The organic material is then injected into the high velocity airstream and routed into a work chamber. The work chamber terminates within a micronizing dryer. The raw organic material is then pulverized the within the work chamber and dried within the micronizing dryer. The pulverized raw organic material is then recovered as a finished product. The injected organic material is micronized the within the working chamber to form the finished product. Optionally, the organic source material may be initially pre-dried in a dryer, and optionally may be dewatered to form a dewatered organic source material. Also, the high velocity airstream containing the injected organic material may be routed through the working chamber prior to entry into a separation cyclone, with the working chamber wrapped around the cyclone in a spiral form. In a preferred alternative, a predryer may be heated with an exhaust airstream from the separation cyclone.

### BRIEF DESCRIPTION OF DRAWINGS

FIG. 1 is a schematic of a preferred process of the present invention;

FIG. 2 is a schematic of a preferred alternative in a drying process of the present invention;

FIG. 3 is a schematic of a preferred alternative in a drying process of the present invention;

FIG. 4 is a schematic of a preferred alternative in a drying process of the present invention;

FIG. 5 is a schematic of a preferred alternative in a drying process of the present invention; and

FIG. 6 is a schematic of a preferred alternative in a drying process of the present invention.

### DETAILED DESCRIPTION OF PREFERRED EMBODIMENTS

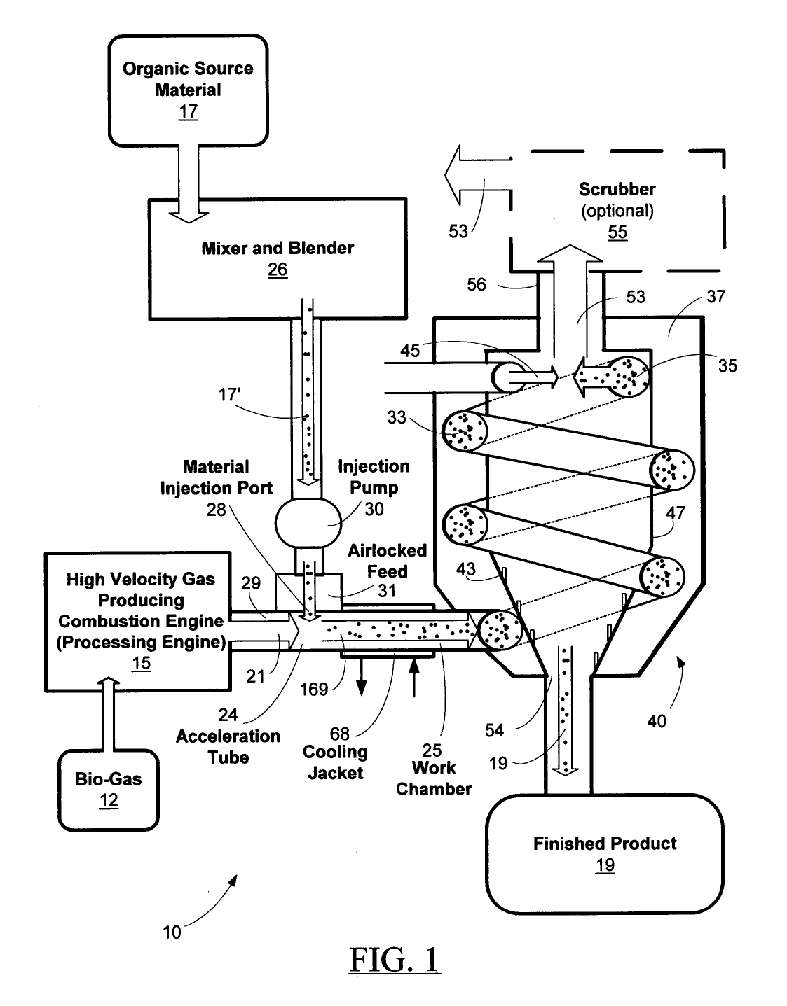

The present invention provides for an economical, environmental friendly system or process for a drying, and micronizing or pulverizing of an organic source material, without composting the organic nutrient and particle sources. As shown in FIG. 1, the drying system 10 can utilize a biogas 12, such as hydrogen, or alternatively, a hydrocarbon such as methane, propane, natural gas, ethanol or diesel, as its source of fuel, in a processing engine 15, to drive off and separate the bound and free water, naturally present in an organic source material 17, or raw feed stock. Simultaneously, the system can also reduce particle size of the organic source material, being dried through collisions and high velocity friction as a result of the system's configuration. A finished product 19 of the drying system is a disinfected, user friendly, nutrient source that can be used as is, or alternatively upgraded into a fuel source for incineration, to produce heat, electrical and mechanical power.

As shown in FIG. 1, a high velocity gas stream 21, which is hot and preferably above 150 degrees F, is produced with the processing engine 15 using hydrogen, or hydrocarbon carbon biogas 12, as discussed above. The processing engine is preferably a specially designed micro-turbine, a pulse detonating jet engine, or other hot gas producing combustion engine.

A preferred processing engine 15 is the Roots™ brand of compressor, as manufactured by Dresser, Inc., of Addison, Tex. The Roots™, or equivalent compressor, is most preferably a centrifugal type of compressor, able to utilize the biogas 12, or similar type of fuel to generate the required high velocity gas stream 21 for use in the acceleration tube 24 and work chamber 25 of the drying system 10. A most preferred velocity for the high velocity gas stream emitted by the processing engine for use with most organic source materials 17 is approximately 700 ft per second, with a target temperature of approximately 200 degrees F. The inventor has found that achieving and maintaining velocity is more important than controlling temperature of the high velocity gas stream into the work chamber.

An alternative preferred processing engine is the proprietary pulse jet engine, as manufactured by Saddle Rock Technologies, of Wenatchee, Wash. The exhaust gases that result from the controlled explosion of hydrocarbons in the pulse jet engine, propels a ball-shaped hot gas pulse at high velocity, down an acceleration tube 24, into a work chamber 25 at supersonic speeds of up to approximately 6,000 ft per second. The combustion temperature of this preferred processing engine may reach as high as approximately 2,500 degrees F., and as high as approximately 300 psi of force may be generated as head pressure of the projectile of the hot gas pulse. The term “approximately” is used herein to refer to a range of measurable values or relative orientations, understood by a person skilled in the pertinent field or skill, as being substantially equivalent to the herein stated values in achieving the desired results, a range typical to the accuracy and precision of conventional tooling, instrumentation or techniques, or a functionally equivalent range of features that produces equivalent results to those described herein.

With the drying system 10 of the present invention, these forces of energy, in the form of velocity and heat, are then manipulated to maximize their efficiency in a drying and a particle size reduction of the organic source material 17. The organic source material is metered into the system from a blender and mixer 26, into a material injection port 28, which is preferably located at a distal end of the processing engine 15, proximate to an engine exhaust port 29, and immediately prior to the work chamber 25. The organic source material from the blender and mixer may be referred to as a blended and mixed organic source material 17′, as shown in FIG. 1.

As also shown in FIG. 1, the injection of the organic source material 17 into the work chamber 25 is accomplished with the aid of an injection pump 30, such as the preferred “Moyno®” brand of PowerFlow™” pumps, as manufactured by Moyno, Inc., of Springfield Ohio, USA, or alternatively, “Boston Shearpump™” brand of pumps, as manufactured by Admix, Inc., of Manchester N.H., USA. Additionally, an airlocked feed 31 is also employed to prevent the high velocity gas stream 21 from backing up into the injection pump and to the mixer and blender 26. The design and configuration of airlocks for material feeds are well known to those skilled in industrial material handling. Preferably, the airlocks include a pair of gates, to alternately open and close, timed with operation of the injection pump.

One of several possible configurations of the work chamber 25 that is preferably employed for the drying system 10 of the present invention is a spiral coil tube 32, as shown in FIG. 1, which requires particles 33 of the processed organic source material 17 to constantly strike the curved surface as it made its high speed journey to a distal end 35 of the spiral coil tube, which is functioning as the work chamber 25. These spiral coils may be wrapped with a sound and heat insulation 37, and preferably wind around a separation cyclone 40, to conserve space and heat.

The work chamber 25 may also employ collision obstacles 43, such as active baffles, blades, chains, and various other such well known barriers, to accomplish the desired process work. Examples of such collision obstacles are found in the KDS Micronex™ system manufactured by First American Scientific Corporation of Las Vegas, Nev., and the Powermaster Model “M,” manufactured by Karl W. Schmidt and Associates of Commerce City, Colo. As an alternative, the work chamber may be provided with a supplemental compressed air feed 45, to best accomplish the desired drying and micronizing results.

As discussed above, at the distal end 35 of the spiral coil tube 32, or terminal end of the work chamber 25, as a component of the micronizing dryer 40, a separation cyclone 41 is preferably utilized to remove the particulate, final product 19. The separation cyclone is a conventional device, well known to those skilled in industrial material separation and pollution control technologies. The separation cyclone directs an exhaust stream 52 upward, from an exhaust port 56, which primarily includes a heated water vapor 53. The dried, particulate product falls downward within the separation cyclone to exit through a bottom outlet 54, by operation of gravity and cyclonic separation. A scrubber 55 may be employed to remove any residual particulate from the exhaust stream, as well as entrained droplets of moisture. Like the separation cyclone, the scrubber is a conventional device, well known to those skilled in industrial material separation and pollution control technologies.

For use with the system 10 of the present invention, each processed organic feed stock utilized as the organic source material 17, will have a specialized and optimal configuration matrix of: engine geometry and energy source pairing; acceleration tube configuration and work chamber design; and cyclone separation chamber selection. This optimal matrix is most preferably selected to meet the organic source material's specific drying and particle size reduction needs.

Waste heat created by the system 10 may also be employed to pasteurize waste water streams often associated with large animal feeding and dairy cattle operations. As shown in FIG. 1, a cooling jacket 68 may be included surrounding the acceleration tube 24 and optionally the work chamber 25 to heat this waste water stream and cool the processing engine 15, thereby serving as a cooling system for the processing engine.

As discussed above, the micronizing dryer 40 includes a work chamber 25 that preferably terminates into the separation cyclone 41, to segregate the dried and pulverized organic source material particulate 33 into the finished product 19 and a waste airstream 53. The finished product is particulate material that exits the separation cyclone at a bottom outlet 54, and the vapor exhaust of the waste airstream exits from the separation cyclone at a top outlet 56. The spiral coil tube may be wrapped with a sound and heat insulation 37, and preferably around the separation cyclone and the working chamber of the micronizing dryer, to conserve space and heat, while suppressing noise. The working chamber can heat the cyclone to conserve energy and provide a superior drying effect, when compared to conventional drying systems.

The high velocity processing within the micronizing dryer 40, including its work chamber 25, may also employ a collision obstacle 43, such as active baffles, blades, chains, and various other such well known types of barriers, to accomplish the desired process work. Examples of such collision obstacles are found in KDS Micronex™ system, discussed herein above, and the Powermaster Model “M,” manufactured by Karl W. Schmidt and Associates of Commerce City, Colo. As an alternative, as shown in FIG. 1, the micronizing dryer may be provided with a supplemental compressed air feed 45, to best accomplish the desired drying and micronizing.

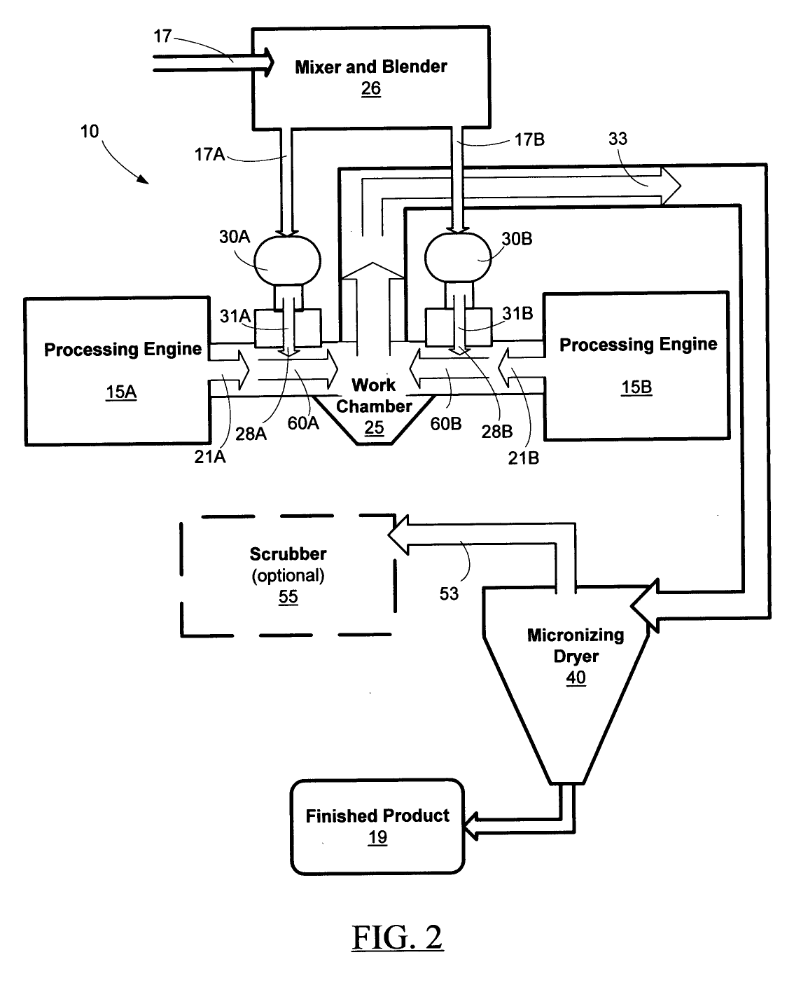

In an alternative embodiment of the drying system 10 of the present invention, shown in FIG. 2, instead of the single high velocity gas stream 21, with a single processing engine 15, opposed high velocity gas streams 60A and 60B from a primary processing engine 15A, and a secondary processing engine 15B, opposed to the primary engine, may be employed for the purpose of improving size reduction and drying of the processed particles 33. Most preferably, one of the opposed high velocity gas stream is injected with a primary organic source material 17A and the other opposed high velocity gas stream is injected with a secondary organic source material 17B. The suffix designation “A” is used herein and on the referenced drawing figures to denote a first or primary instance of a particular element or component, in contrast to the singular or “stand-alone” instance of that same component, without the “A” designation.

The secondary organic source material 17B is preferably generally similar to the primary organic source material 17A, in physical characteristics, such as moisture and consistency, to simplify material handling and mixing. The secondary organic source material is metered into the drying system 10 at a secondary material injection port 28B, preferably located at a second distal end 35B of the secondary processing engine, proximate to a secondary engine exhaust port 29B and prior to the work chamber 25. Alternatively, by minimizing the length of the work chamber, the colliding of the opposing secondary high velocity gas stream with the primary high velocity gas stream 21A may take place within the micronizing dryer 40.

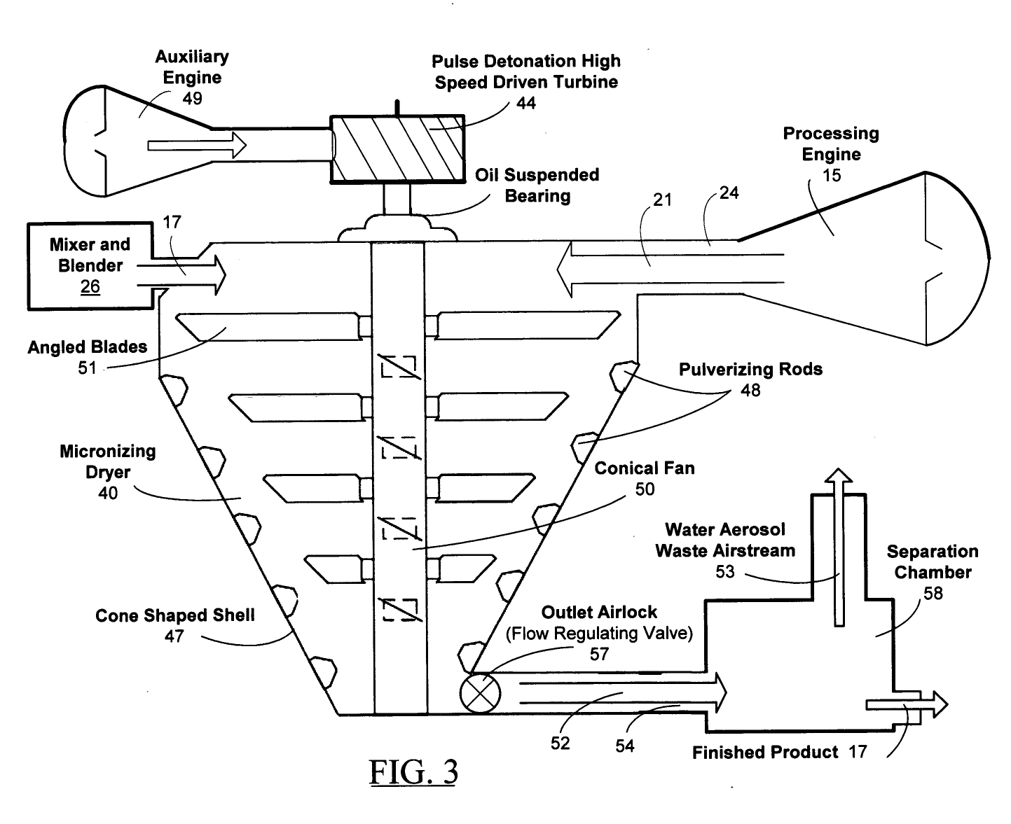

In an additional alterative drying system 10 of the present invention, a conical fan tower 46, as shown in FIG. 3, may be utilized as the work chamber 25 and micronizing dryer 40. The conical fan tower includes a cone shaped shell 47, and is preferably equipped with pulverizing rods 48, spaced along the interior of the cone shaped shell. An auxiliary engine 49 is preferably utilized to drive a conical fan 50 within the cone shaped shell. The auxiliary engine is preferably processing engine 15, and most preferably a pulse jet engine, as discussed above, or may be any motor or engine, able to provide the power required for the rotation of the conical fan. The auxiliary engine may be used to drive a turbine 44, as also shown in FIG. 3, which in turn, drives the conical fan of the alternative micronizing dryer. The conical fan may include angled blades 51, as shown schematically in FIG. 3, or may include lengths of chain or cable, as conventionally employed in KDS Micronex™ system, discussed above.

As with the embodiment shown in FIG. 1, the processing engine 15 in the preferred embodiment shown in FIG. 3 delivers the hot, high velocity gas stream 21 to the micronizing dryer 40. For this alternative configuration, the acceleration tube 24 from the processing engine mixes with the organic source material 17 in a turbulent combination within the comical fan tower 46, which acts as the work chamber 25. The organic source material may be fed directly into the comical fan tower from the mixer and blender 26. Again, the processing engine employed with the acceleration tube and work chamber is a high velocity gas producing combustion engine. The processing engine may be a standard “roots” type of positive displacement blower discussed above, or more preferably a standard “pulse” type of engine, which generates the high velocity gas required for the acceleration tube.

The comical fan tower 46, as with any preferred micronizing dryer 40, generates an exhaust stream 52 that contains the product particulate 33. As shown in FIG. 3, a flow regulating valve acts as an outlet airlock 57, to meter the exhaust stream 52 containing the finished product 19 into a separation chamber 58. The outlet airlock may be any conventional device that prevents the back flow of the exhaust stream and stream of product particles. Paddles, augers and geared inlets of conventional design are also considered for use.

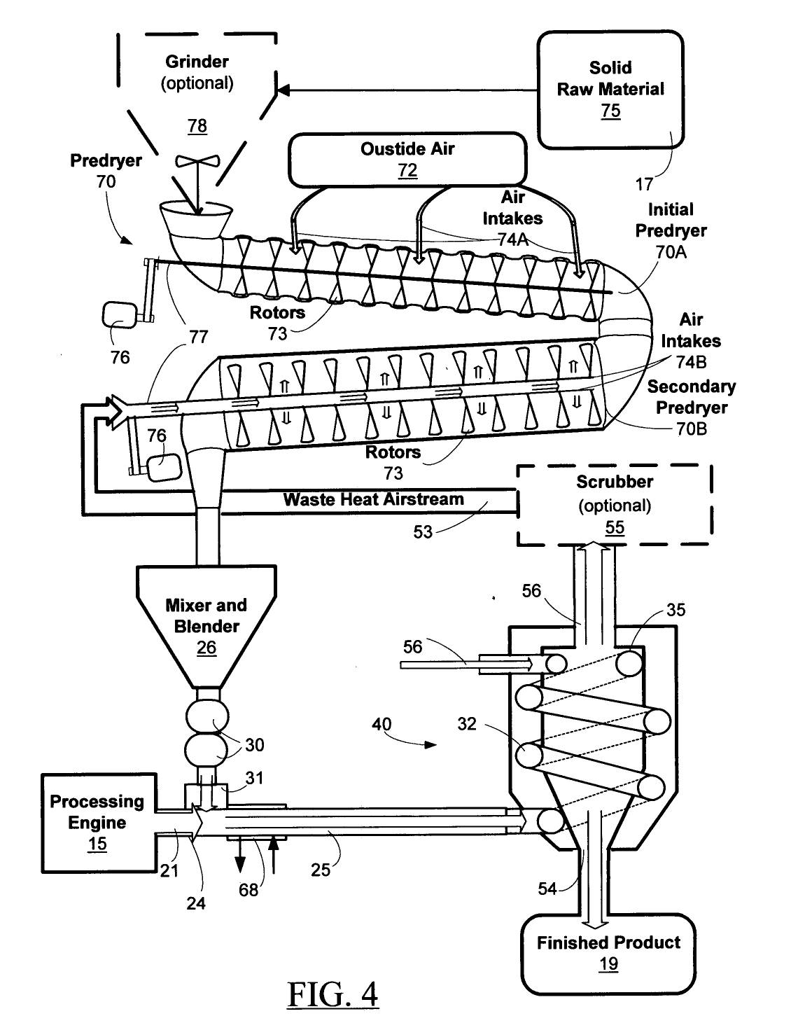

In an alternative embodiment of the drying system 10 of the present invention as shown in FIG. 4, a predryer 70 is preferably employed to prepare the organic source material 17, such as when it is a solid raw material 75. As detailed in FIG. 4, a grinder 72 may be utilized to reduce the size or fiber length of the solid raw material. The grinder is such as the model “1101GH” of the AUTIO brand of grinder, as manufactured by the Autio Company, of Astoria Oreg., USA, or alternatively, a conventional 1101GH model of AUTIO brand of grinder which includes a high speed pulverizing head, or a “FitzMill®,” or Fitzpatrick brand of mill, manufactured by Fitzpatrick, Inc., of Elmhurst, Ill., USA, or alternatively a Silverson mixer-homogenizer, as manufactured by Silverson Machines LTD., of Chesham Bucks, U.K., could be utilized. An additional alternative grinder is the “CORNECO™” model M12A disintegrator, manufactured by Corneco, Inc., of Sebasopol Calif., USA. Additionally, the grinder may be any conventional grinder selected by a person skilled in such selections, for use to meet the needs of this particular process step.

From the grinder 72, the solid raw material 75 is routed to the predryer 70. The design of the predryer is preferably similar to the configuration shown in FIG. 4, with a plurality of rotors 73, spaced regularly upon a shaft 77, housed within a dryer tube 78. The dryer tube is preferably a corrugated culvert or pipe, with wavelike shaped walls that precisely receive the curved blades of the rotors. A preferred rotor is a conventional roto-tiller type of rotor blade, with a length of approximately 18 inches, and a curved blade sized to fit into the wall of the dryer tube and track the circumferential trough of the dryer tube when the rotor rotates about the shaft. A preferred diameter of the dryer tube is approximately 3 feet and has a length of approximately 40 feet. The shaft is rotated by a shaft motor 76.

Most preferably, the predryer 70 includes two flights or segments, as shown schematically in FIG. 4. To aid in drying, the predryer preferably includes a plurality of air intakes 74 at regular intervals to direct outside or ambient air 72 into the predryer. Preferably, this outside air stream is preheated by conventional method, but most preferably the waste airstream 53 from the top outlet of the micronizing dryer 40 is routed into the predryer, to provide for excellent removal of moisture from the solid raw material 75.

After exiting from the predryer 40, the predried solid raw material is routed to the processing engine 15, as shown in FIG. 4. The mixer and blender 26 is employed to add any additional ingredients needed for a desired chemical composition of the finished product 19 and to homogenize or average out potential irregularities in the organic source material 17. A standard, bucket conveyor may be utilized to transfer the material from the predryer to the mixer and blender, and a preferred mixer and blender combination is a “Marion Mixer™,” such as the model 6301, as manufactured by Marion Mixers, Inc., of Marion, Iowa.

The injection of the organic source material 17 into the work chamber 25 is accomplished with the aid of an injection pump 30. As shown in FIG. 4, two pumps in series may be used to increase the pressure of the organic source material feed, and minimize back-flow, out of the work chamber. Additionally, the airlocked feed 31 is also employed to help prevent the high velocity gas stream 21 from backing up into the injection pump and to the mixer and blender 26. The design and configuration of airlocks for material feeds are well known to those persons skilled in industrial material handling.

For the embodiment of FIG. 4, a preferred processing engine 15 is the Roots™ brand micro-turbine, which produces the required heated and high velocity gas stream 21, also injected into work chamber 25, through the acceleration tube 24. A preferred configuration of the work chamber is a spiral coil tube 32, as shown in FIG. 4, as discussed above in relation to FIG. 1 and requires particles 33 of the processed organic source material 17 to constantly strike the curved surface as it made its high speed journey to a distal end 35 of the spiral coil tube.

As also discussed above, the separation cyclone 41, preferably located within the spiral tube coil 32, is utilized to remove the finished product 19 in its particulate form 33. The separation cyclone may be a conventional device well known to those persons skilled in industrial material separation technologies. The dried particulate, finished product circulates centrifugally and falls downward within the separation cyclone, exiting through the bottom outlet 54, by operation of gravity and cyclonic separation.

From its top outlet 56, the separation cyclone 41 directs a waste airstream 53, primarily comprising heated water vapor, or steam. This waste heat airstream created by the processing engine 15 and ejected by the micronizing dryer 40, may also be employed for any heating, process or co-located need. Most preferably, this waste heat airstream is injected into the predryer 70 countercurrent to the flow of organic source material through the predryer, as shown in FIG. 4. Additionally, the cooling jacket 68 may be included surrounding the acceleration tube 24 and the work chamber 25, to heat a water stream and remove heat additional heat from the system.

For use with the drying system 10 of the present invention, each type of organic source material 17 utilized as a source material, has a specialized and optimal configuration matrix of: predryer 70 and micronizing dryer 40 geometry, energy source pairing; acceleration tube 24 configuration and work chamber 25 design; along with processing time and temperature. For example, decreasing the diameter of the spiral coil tube 32 will compress the air stream of product particles 33, and increase air velocity and temperature within the work chamber. For initial passes with wet sludges, a relatively low velocity of 100 ft per second may adequately initially dry and pulverize the organic source material. Increasing the diameter of the spiral coil tube will slow the air stream containing the product particles, and cool the temperature within the work chamber. This is useful when choosing an air source, whether it is compressed air from the “Roots™” compressor, or exhaust air generated from a “pulse” type of engine. This optimal matrix is most preferably selected to meet the raw organic source material 17, or equivalent source material's specific drying and particle size reduction needs, and economic realities.

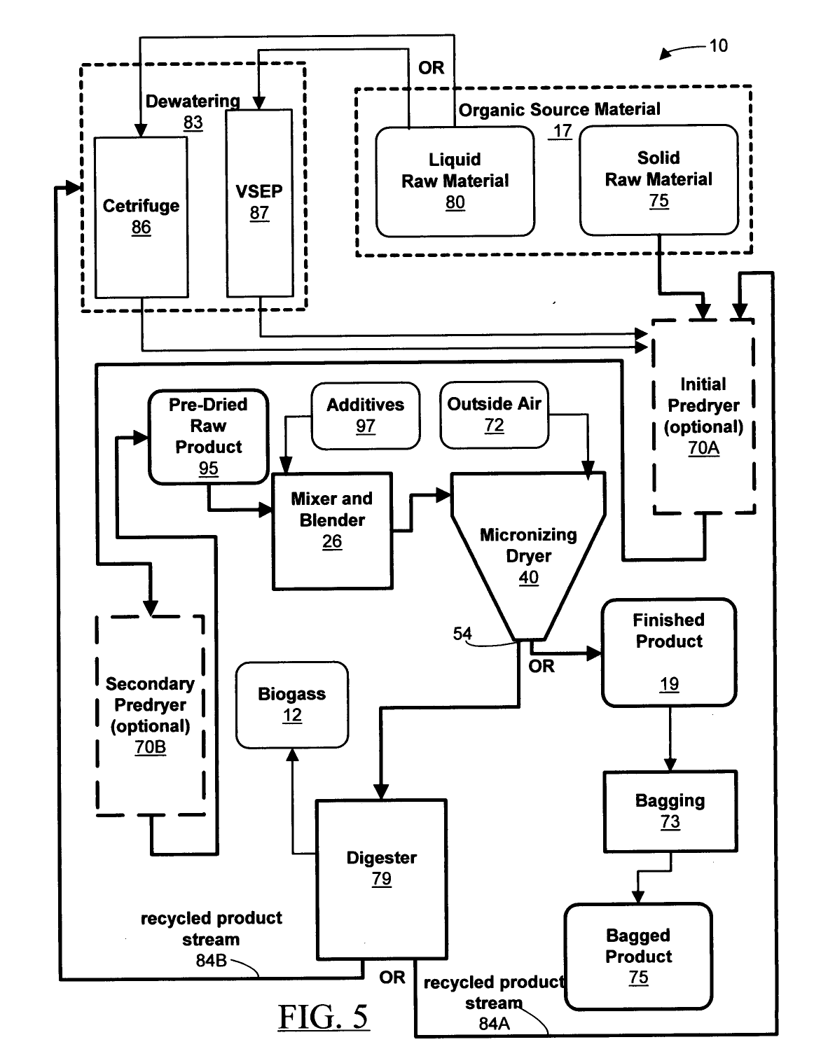

An alternative to the process of FIG. 4 is shown in FIG. 5 and employs an initial predryer 70A, for processing an organic source material 17 that is a solid raw material 75. Especially for processing bio-solids or sludges, the initial predryer may be embodied with the first stage of the predryer 70, as shown in FIG. 4, and preferably includes the addition of outside air 72 into air intakes 74A, spaced along the predryer. The initial predryer is desirable in that it drives of some water and can serve to homogenize and blend, breaking up clumps and clods within the feed of organic source material. As shown in FIG. 5, a recycled product stream 84A, routed from a digester 79 can serve to condition the solid raw material. An approximate 1:1 ratio of recycled product to the raw material, by weight, is ideal for “bulking-back” or reducing the moisture content of the solid raw material and providing a pre-dried raw product 95 that responds well to the micronizing drier 40.

In an alternative routing of the recycled product stream 84B, routed from the digester 79, as also shown in FIG. 5, can serve to condition the liquid raw material 80. The recycled product stream is introduced into the dewatering 83. As with the solid raw material 75, an approximate 1:1 ratio of recycled product to the raw material, by weight, is ideal for bulking-back the liquid raw material and providing a pre-dried raw product 95 that responds well to processing in the micronizing drier 40.

As an additional preferred option of the dryer system 10 of the present invention, the predryer 70 can include a secondary predryer 70B, located after the initial predryer 70A with the routing as shown in FIGS. 4 and 5. The secondary predryer preferably includes an air intake 74B, as shown in FIG. 4, which utilized the waste heat airstream 53 form the top outlet 56 of the separation cyclone 41 or as optionally processed by the scrubber 55. The preferred air distribution to the secondary predryer is counter-flow, as discussed above, additionally with the waste heat airstream introduced along a central core pipe, acting as the shaft 77.

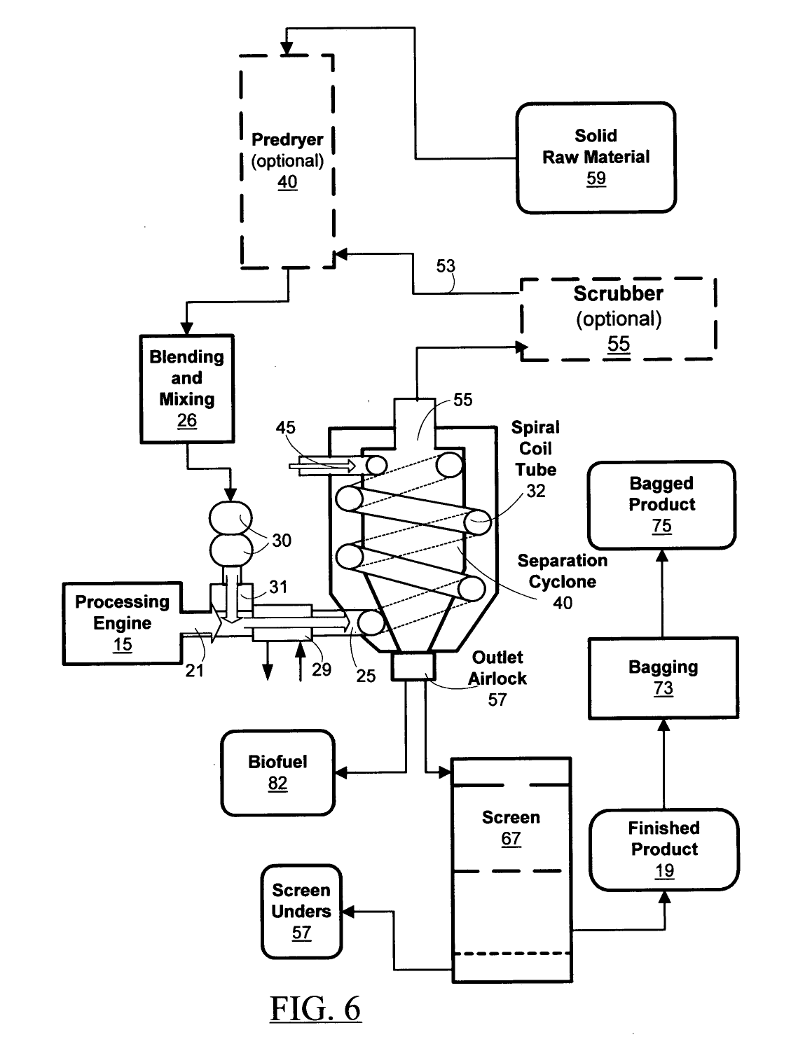

From the micronizing dryer 40 the material produced from the bottom outlet 54 may be considered finished product 19, and optionally directed to bagging 73 operations to achieve a bagged product 75, or alternatively routed to the digester 79, as would be appropriate for when a biomass material is the solid raw material. In this alternative drying system 10, the digester may be any conventional anaerobic digester device or system, preferably a “plug flow” digester, as known to those persons skilled in the design and operation of such systems. A beneficial by product of the digester may be the generation of the biogas 12, as can be utilized as the fuel for the processing engine 15, as shown in FIGS. 1, 3, 4 and 6, in processing engines 15A or 15B, as shown in FIG. 2, or the auxiliary engine 49, as shown in FIG. 3.

When the organic source material 17 is a liquid raw material 80, a dewatering 83 process is preferably employed as a preprocessing of the organic source material. For the liquid raw material, a centrifuge 86, may be utilized to extract water from the liquid raw material. The centrifuge must be selected for low power consumption at the desired high through-puts. A most preferred centrifuge is the “ERTH®” tubular centrifuge, as manufactured by Erth Technologies, Inc., of Longmont Colo., USA.

An alternative system for dewatering 83 employs reverse osmosis, such as utilized in a preferred “VSEP®” 87 membrane filtration system, as manufactured by Esmil Process Systems of High Wycombe, UK. The VSEP system utilizes vibratory shear-wave, for the efficient removal of solids from viscous, slow flowing slurries, with high concentrations of suspended solids.

The type of grinding 71 or dewatering 83 system can greatly reduce or eliminate the need for the predryer 70, as shown in FIGS. 4 through 6. However, the predryer serves to produce the pre-dried raw product 95, which is ready for further processing by the micronizing dryer 30. Preferably, the blender mixer is employed to prepare the pre-dried raw product for introduction into the micronizing dryer 40.

Also, for the drying system 10 of the present invention, the blender and mixer 26 can then be used, to introduce additives 97, such as additional organic material to the pre-dried raw product 95. The finished product 67 is a fine mesh, dry powder useful as a organic or feed.

### EXAMPLE 1

Dairy manure collected from a screen separation pile next to a waste water settling pond was collected and analyzed for moisture, and found to contain 70% water by weight. This material was used as the organic source material 17 and metered into the acceleration tube 24 near the combustion chamber of a pulse engine 15, as manufactured by Saddle Rock Industries. The resultant manure out the end of the water-separating cyclone was 18% water by weight, with the particles 33 sized at 60% passing through a standard 25 mesh screen.

### EXAMPLE 2

An organic-based material containing 70% feedlot manure by weight, and standard analysis of 12-3-2 NPK, was mixed with water to a saturation of 60% water by weight, and then metered into the system 10 employing a pulse jet processing engine 15, as with example 1, above. This organic source material 17 was sticky and difficult to manage but was found to pass through the system with a final result of 12% moisture by weight with the following screen sizes as compared before and after processing. The 27 cubic inch or about 0.015 cubic foot combustion chambered pulse engine ran at about 750 firings/min to produce 11 cu ft of hot, high speed air per minute. The gaseous pulse or ball of the high velocity gas stream 21 produced around 300 psi of impact force. The organic source material was feed into the acceleration tube and processed through the work chamber in the form of the spiral coil tube, of about 30 feet of a 1.25 inch pipe. The diameter of the spiral was approximately 3 feet. The pipe was insulated and emptied into a conventional 15 cubic feet of volume separation cyclone 40, for separation of the water from within the cyclone. There was considerable movement of the particles in the separation cyclone due to a restriction of the incoming air at the point of entry so as to increase the speed of the entering gas. This restriction caused a back pressure of about 9 psig on the pulse engine without any adverse problems on its function. This restriction also increased dwell time of the raw feedstock while traveling down the coiled tube. No steam was observed and the moisture seen coming out of the top 57 was just slightly above body temperature. The ambient temperature was around 70 degrees F., and the final product 19 measured 12% moisture by weight, out the bottom outlet 54 of the cone.

A screening test was performed on the final product 19. 100 grams of the particulate final product that had already passed through a 25 standard mesh was screened, with the following results, by weight:

53% under 25 standard mesh and over 50 standard mesh;

13.5% under 50 standard mesh and over 100 standard mesh; and

36.5% under 100 standard mesh (or 150 microns).

The final product 19 was powder-dry and was able to be worked through the screen 67 with gentle hand stirring. As a check, a sample of the raw feedstock or organic source material 17 was dried in a microwave and screened in a similar fashion, so a comparison could be made to see how much particle reduction was achieved from the high velocity processing engine 15, and the spiral coil tube 31 of the work chamber 25. The results for this unprocessed material is as follows:

32% over 4 standard mesh;

32.5% over 25 standard mesh;

21.5% under 25 standard mesh and over 50 standard mesh;

8.8% under 50 standard mesh and over 100 standard mesh;

5.5% under 100 standard mesh 150 microns).

From the above two examples, it was found that the drying increased with the increased lengthening of the spiral coil tube 31. With this ability to change the coil's length and diameter to accommodate various organic source materials 17 and moisture content, one could produce a “signature of equipment configuration” to match each situation.

Through further testing, the drying system 10 of the present invention was found to process potatoes, carrots, and it expected that most other vegetable wastes. Additionally, the drying system is well suited to process other manure waste products, and is especially efficient in the processing of chicken litter. Liquid waste streams such as municipal bio-solid pond effluent, dairy, hog waste pond effluent and brewers waste, are all considered as excellent probable organic source materials for use with the drying system.

Because these organic waste streams are varied in composition and properties, a flexible system is required to accommodate the different moistures and material characteristics. Selecting a process for any given waste is determined by the finished product desired, along with cost, and convenience.

### EXAMPLE 3

150 lbs. of poor quality or “cull” potatoes utilized as the organic source material 17 were run through a CORNECO™ grinder 72, after which an initial moisture test showed 80% water, by weight. The optional predrying 70 was not performed. After a first pass through the micronizing dryer 40, approximately 66 lbs. of water was removed, to produce a 45% solid product. After a second pass through the micronizing dryer, 47 lbs. of water was removed to produce a bone dry finished product 19, with 94% solids, by wight.

It is estimated that processing the organic source material 17 after the first grind 72, through the CORNECO™ or any other grinder suitable for this purpose, with the predryer 70, will reduce the free water moisture to a level that only one pass through the micronizing dryer 40 would be necessary thus reducing cost and time by doubling production. The through put rate should be easily able to approach approximately 2 ton/hour of the raw, pre-dried waste through the standard sized drying system 10.

Having now described the invention, to those persons skilled in the art to which it pertains, it may become apparent that the need to make modifications without deviating from the intention of the design as defined by the appended claims.

What is claimed is:

1. A process and for drying and pulverizing an organic material comprising the steps of:
a) generating a high velocity airstream, the high velocity airstream having sufficient temperature to vaporize substantially all water present in the organic material;
b) injecting the organic material into the high velocity airstream;
c) routing the high velocity airstream with the injected organic material into a work chamber, the work chamber terminating within a micronizing dryer;
d) pulverizing the raw organic material within the work chamber;
e) drying the raw organic material within the micronizing dryer; and
f) recovering the dried and pulverized raw organic material as a finished product.

2. The process of claim 1, additionally comprising the step of:
g) initially pre-drying the organic source material in a dryer;

3. The process of claim 1, additionally comprising the step of:
g) dewatering the organic source material to form a dewatered organic source material;

4. The process of claim 1, additionally comprising the step of:
g) routing the high velocity airstream containing the injected organic material through a working chamber prior to entry into a separation cyclone, the working chamber wrapped around the cyclone in a spiral form; and
h) micronizing the injected organic material within the working chamber to form the finished product.

5. The process of claim 4 additionally comprising the step of:
I) heating a predryer with an exhaust airstream from the separation cyclone.

6. A drying apparatus for a pulverized organic product comprising:
a processing engine for generating a high velocity airstream and directing the high velocity airstream into an acceleration tube, the high velocity airstream having sufficient volume, heat and velocity to vaporize substantially all water present in an organic material stream;
a work chamber mounted to the acceleration tube of the processing engine, the high velocity airstream routed into the work chamber, and the work chamber terminated within a micronizing dryer;
an injector pump to inject the organic material into the work chamber for interaction with the high velocity airstream;
the raw organic material pulverized and dried within the micronizing dryer; and
the dried and pulverized raw organic material recovered from the micronizing dryer as a finished product.

7. The drying apparatus of claim 6, additionally comprising:
a predryer to initially pre-dry the organic source material prior to injection the organic material into the work chamber.

8. The drying apparatus of claim 6, additionally comprising:
a dewatering device to remove liquid water from the organic source material to form a dewatered organic source material.

9. The drying apparatus of claim 6, wherein the working chamber terminates with a separation cyclone, and the working chamber wraps around the cyclone in a spiral form to transfer heat to the separation cyclone.

10. The drying apparatus of claim 9, wherein an exhaust airstream from the separation cyclone heats a predryer, the organic source material processed by the predryer prior to injection of the organic source material into the work chamber.
